(19) United States
(12) Patent Application Publication
(10) Pub. No.: US 2015/0097702 A1
(43) Pub. Date: Apr. 9, 2015

(54) BLIND SPOT SENSING APPARATUS AND METHOD

(71) Applicant: MANDO CORPORATION, Pyeongtaek-si (KR)

(72) Inventor: Nac Dong KIM, Siheung-Si (KR)

(21) Appl. No.: 14/308,597

(22) Filed: Jun. 18, 2014

(30) Foreign Application Priority Data
Oct. 7, 2013 (KR) 10-2013-0119278

(51) Int. Cl. G08G 1/16

(52) U.S. Cl. CPC G08G 1/167
USPC 340/901

(57) ABSTRACT

Disclosed are a vehicle blind spot sensing apparatus and method. The blind spot sensing apparatus includes: a transceiver unit configured to transmit/receive a signal for sensing an object existing in a vehicle blind spot; a sensing unit configured to sense the object by receiving the signal; a determining unit configured to determine whether the object is an object to warn about based on whether the sensed object moves or not; and a warning unit configured to generate a warning signal when it is determined that the object is the object to warn about.

### CROSS-REFERENCE TO RELATED APPLICATION

This application claims priority from and the benefit under 35 U.S.C. §119(a) of Korean Patent Application No. 10-2013-0119278, filed on Oct. 7, 2013, which is hereby incorporated by reference for all purposes as if fully set forth herein.

### BACKGROUND OF THE INVENTION

1. Field of the Invention

The present invention relates to a vehicle blind spot sensing apparatus and method.

2. Description of the Prior Art

Hitherto, blind spot sensing systems have been developed which recognize an object existing in a vehicle blind spot and issues a warning so at to prevent accidents caused when a driver does not recognize the object existing in the vehicle blind spot.

Such a blind spot sensing system has a problem in that, due to a characteristic an ultrasonic sensor, the blind spot sensing system cannot distinguish an object moving in a vehicle blind spot and a fixed object existing in the vehicle blind spot, such as a guard rail, from each other.

In such a case, an unnecessary warning may be issued or no warning may be issued although the warning is needed since the moving object and the fixed object are not distinguished from each other.

### SUMMARY OF THE INVENTION

In this background, an object of the present invention is to provide a blind spot sensing apparatus and method which sense a water spray generated by a moving object in case of rain or on a wet road so as to differentiate the moving object and the fixed object from each other.

Another object is to provide a blind spot sensing apparatus and method which determine whether an object sensed through a sensor is an object to warn about and issue a warning only for the object to warn about.

In order to achieve the above-described objects, in accordance with an aspect of the present invention, there is provided a blind spot sensing apparatus including: a transceiver unit configured to transmit/receive a signal for sensing an object existing in a vehicle blind spot; a sensing unit configured to sense the object by receiving the signal; a determining unit configured to determine whether the object is an object to warn about based on whether the sensed object moves or not; and a warning unit configured to generate a warning signal when it is determined that the object is the object to warn about.

According to another aspect of the present invention, there is provided a blind spot sensing method including: transmitting/receiving a signal for sensing an object existing in a vehicle blind spot; sensing the object by receiving the signal; determining whether the object is an object to warn about based on whether the object moves or not; and generating a warning signal when it is determined that the object is the object to warn about.

As described above, according to the present invention, it is possible to provide a blind spot sensing apparatus and method which sense water sprays generated by a moving object in case of rain or on a wet road so as to differentiate the moving object and the fixed object from each other.

Further, it is possible to provide a blind spot sensing apparatus and method which determine whether an object sensed through a sensor is an object to warn about and issue a warning only for the object to warn about.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating a situation where a vehicle senses an object in a blind spot according an exemplary embodiment of the present invention;

FIG. 2 is a block diagram of a blind spot sensing apparatus according to an exemplary embodiment of the present invention;

FIG. 3 is a view exemplifying a situation in which water sprays generated by an object existing in a blind spot are sensed according to another exemplary embodiment;

FIG. 4 is a view exemplifying waveforms of reflection signals received by being reflecting from a moving object and a fixed object according to still another exemplary embodiment of the present invention;

FIG. 5 is a flowchart illustrating a method of determining an object to warn about based on reflected signals by a blind spot sensing apparatus according to yet another exemplary embodiment of the present invention; and

FIG. 6 is a flowchart of a method of sensing a blind spot according to yet another exemplary embodiment of the present invention.

### DETAILED DESCRIPTION OF THE EXEMPLARY EMBODIMENTS

The present invention discloses a blind spot sensing apparatus and a blind spot sensing method.

Hereinafter, exemplary embodiments of the present invention will be described with reference to the accompanying drawings. In the description of the elements of the present invention, terms “first”, “second”, “A”, “B”, “(a)”, “(b)” and the like may be used. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

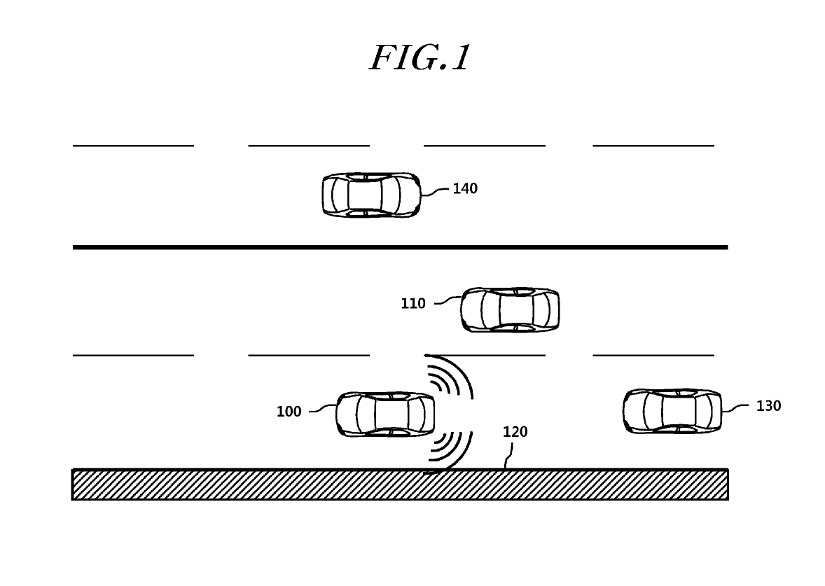

FIG. 1 is a view illustrating a situation where a vehicle senses an object in a blind spot according an exemplary embodiment of the present invention.

A blind spot sensing apparatus refers to an apparatus that senses an object or danger in a vehicle blind spot which is not easily recognized by a driver of the vehicle, and provides a warning to the driver.

The term, “blind spot sensing apparatus” discussed herein may be used to include a system, such as a Blind Spot Warning System (BSWS), a Blind Spot Information System (BSIS), a side blind zone alert system, a blind spot detection system, or a rear vehicle monitoring system.

Specifically, the blind spot sensing apparatus may perform a function of sensing a vehicle or an object when the vehicle or the object approaches to a vehicle equipped with the blind spot sensing apparatus in a left or right blind spot when the vehicle travels and informing a driver of it, which may help prevent an accident.

In addition, the signal transmitted/received by the blind spot sensing apparatus so as to sense an object in a blind spot may include any of signals which are transmitted, reflected by the object and received again, such as an ultrasonic signal or a radar signal.

Herein, although an ultrasonic sensor is described as an example, all signals including the radar signal may be covered.

Referring to FIG. 1, for example, a blind spot sensing apparatus of a vehicle 100 may sense another vehicle 110 and an object 120 positioned in a blind spot of the vehicle 100 while the vehicle 100 travels.

The blind spot refers to an area around the vehicle 100 other than an area which may be confirmed by the driver of the vehicle 100 through a side-view mirror or a rear-view mirror.

The blind spot around the vehicle 100 is not easily recognized by the driver, and the other vehicle 110 or the object 120 positioned in the blind spot may be sensed using a sensing sensor such as an ultrasonic sensor, a radar or a camera.

However, in such a case, there is a problem in that it is difficult for the blind spot sensing apparatus of the vehicle 100 to differentiate the other vehicle 110 which may be a risk element and a fixed object 120, such as a guard rail, and thus, it is difficult for the blind spot sensing apparatus to issue a correct warning.

Accordingly, hereinafter, an exemplary embodiment of the present invention which may distinguish the other vehicle 110 which is an object to warn about and the fixed object 120 which is not an object to warn about will be described in detail with reference to the drawings.

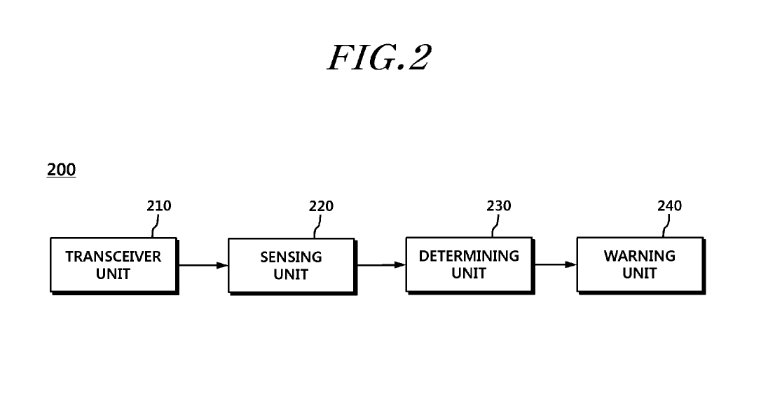

FIG. 2 is a block diagram of a blind spot sensing apparatus 200 according to an exemplary embodiment of the present invention.

According to an exemplary embodiment of the present invention, a blind spot sensing apparatus 200 includes: a transceiver unit 210 configured to transmit/receive a signal for sensing an object existing in a vehicle blind spot; a sensing unit 220 configured to receive the signal to sense the object; a determining unit 230 configured to determine whether the sensed object is an object to warn about based on whether the sensed object moves or not; and a warning unit 240 configured to generate a warning signal when it is determined that the object is the object to warn about.

Referring to FIG. 2, the transceiver unit 210 is attached to the vehicle, and may transmit, for example, an ultrasonic signal or a radar signal and receive the transmitted signal when the transmitted signal is reflected from the object. In addition, the transceiver unit 210 is attached to each of front and rear corners of the vehicle and may transmit a signal to the vehicle blind spot.

According to the exemplary embodiment of the present invention, the sensing unit 220 may sense an object existing in the blind spot based on a reflected signal which is reflected from the object or a water spray generated by the object and received by the sensing unit 220.

For example, the sensing unit 220 may sense the existence of an object in the blind spot, based on a signal transmitted from the transceiver unit 210 and received by the transceiver unit 210 by being reflected by the object existing in the blind spot or a water spray which may be generated by a moving object.

That is, the sensing unit 220 may receive the signal reflected by the water spray generated by the moving object in a case of rain or on a wet road to sense the existence of the object in the blind spot.

In addition, the determining unit 230 may determine whether the object sensed by the sensing unit 220 is an object to warn about. That is, when the object is sensed, the determining unit 230 determines whether the corresponding object is a moving object (e.g., a target vehicle) or a fixed object (e.g., a guard rail).

The determining unit 230 may determine whether the sensed object is the object to warn about with reference to whether the sensed object is a moving object.

For example, when it is determined that the sensed object is moving, the determining unit 230 recognizes the corresponding object as the target vehicle and determines it as the object to warn about. Otherwise, when it is determined that the sensed object is a fixed object, the determining unit 230 determines the corresponding object is not the object to warn about.

The warning unit 240 generates and provides, to the driver, a warning signal according to a result of sensing the blind spot based on the information determined by the determining unit 230.

For example, when the object sensed in the blind spot is the object to warn about, the warning unit 240 may issue a warning to the driver using, for example, visual, audio or tactile means. That is, the warning unit 240 may, for example, generate and output a warning message or a warning sound or generate vibration on a steering wheel so as to issue a warning to the driver.

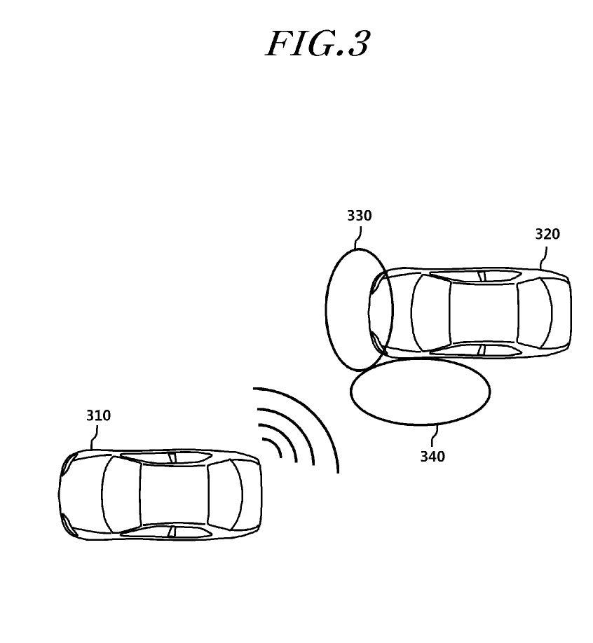

FIG. 3 is a view exemplifying a situation in which water sprays generated by an object existing in a blind spot are sensed according to another exemplary embodiment.

According to the exemplary embodiment of the present invention, the determining unit may determine whether the object is moving by comparing the waveform of the reflected and received signal and a reference waveform.

For example, the determining unit may receive a signal reflected by a water spray generated while an object is moving in a case of rain or on a wet road and to sense the water spray. Then, the determining unit may determine whether the object is moving by comparing the waveform of the reflected and received signal and a pre-set reference waveform.

Referring to FIG. 3, a blind spot sensing apparatus of a vehicle 310 senses the water spray generated by a sensing-target object 320 while the vehicle 310 moves and compares the waveform of the reflected and sensed signal and the pre-set reference waveform.

For example, when the target object 320 is another vehicle, the reflection signal, which is reflected by a water spray generated by the other vehicle 320 while the other vehicle 320 travels, is received.

The water spray may be generated on a front side 330 or a lateral side 340 of the vehicle 320 by the wheels of the vehicle 320 as the other vehicle 320 moves in a case of rain or on a wet road.

The determining unit may determine whether the vehicle is moving based on the waveform of the reflection signal reflected by the water sprays in the areas 330 and 340 where water sprays are generated as illustrated in FIG. 3.

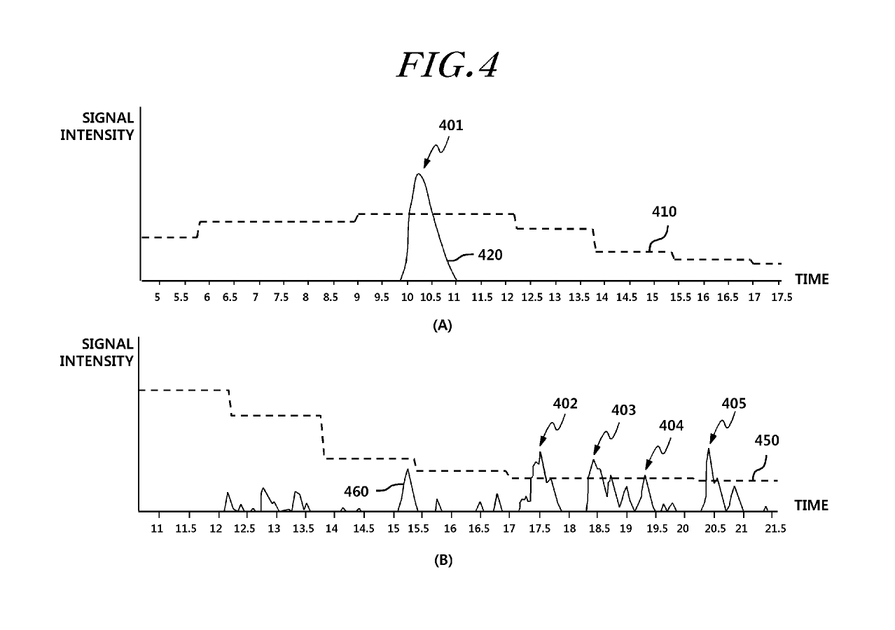

Meanwhile, because a fixed object such as a guard rail does not move and thus, does not generate a water spray, the waveform of a reflection signal reflected by the fixed object and a reflection signal reflected by a water spray have different characteristics. Referring to FIG. 4, detailed operations of the determining unit will be discussed.

FIGS. 4A and 4B are views exemplifying waveforms of reflection signals received by being reflecting from a moving object A and a fixed object B according to still another exemplary embodiment of the present invention.

According to an exemplary embodiment of the present invention, the determining unit determines whether an object is moving by comparing a waveform of a received reflection signal and a reference waveform.

In addition, according to an exemplary embodiment of the present invention, the reflection signal may be a reflection signal which is reflected by a water spray generated by a moving object and received.

Referring to FIGS. 4A and 4B, FIG. 4A is a view illustrating an example of a waveform of a signal reflected by a fixed object and received. FIG. 4B is a view illustrating an example of a waveform of a signal reflected by a water spray generated by a moving object and received.

Referring to FIG. 4A, the waveform 420 of the reflection signal reflected by the fixed object and received has one peak value 401 exceeding the reference signal 410.

Since the signal reflected by the fixed object is received as one reflection signal as described above, a single waveform 420 appears.

Referring to FIG. 4B, the waveform 460 of the reflection signal reflected by the water spray generated by the moving object and received has a plurality of peak values 402 to 405 exceeding the reference signal 450.

Because the waveform 460 of the signal reflected by the water spray is reflected by water droplets of the water spray and received, the received signal has various peak values although the intensity of the signal is weak.

That is, for example, the received reflection signal may be measured as having one peak value or two or more peak values which exceed the intensity of the reference signal.

Accordingly, the determining unit may determine whether the object is moving by comparing each of the waveform 420 of the reflection signal reflected by the fixed object as illustrated in FIG. 4A and the waveform 460 reflected by the water spray as illustrated in FIG. 4B with the pre-set reference waveform 410 or 460.

Specifically, according to an exemplary embodiment of the present invention, when the number of peaks exceeding the reference waveform is equal to or larger than a reference value, the determining unit determines that the object is moving.

That is, for example, in FIG. 4B, the determining unit compares the waveform 460 of the reflection signal and the reference waveform 450 and counts the number of the peaks 402 to 405 of the waveform 460 of the reflection signal which exceed the reference waveform 450.

For example, the number of the peaks 402 to 405 of the waveform 460 of the reflection signal which exceed the reference waveform 450 in FIG. 4B is four. Whereas, the number of peaks 401 of the waveform 420 of the reflection signal which exceed the reference waveform 410 in FIG. 4A is one.

Accordingly, when the pre-set reference value is, for example, two, the determining unit may determine the object corresponding to FIG. 4B as a moving object because the number of peaks of the waveform in FIG. 4B is larger than the reference value. Likewise, the determining unit may determine the object corresponding to the waveform in FIG. 4A as a fixed object because the number of peaks of the waveform 420 is smaller than the reference value.

Thereafter, the determining unit may set the object, from which the waveform of FIG. 4B is received from the object such that the object is determined as a moving object, as an object to warn about. In addition, since the object, from which the waveform of FIG. 4A is received, is a fixed object, the determining unit may not set the object as an object to warn about.

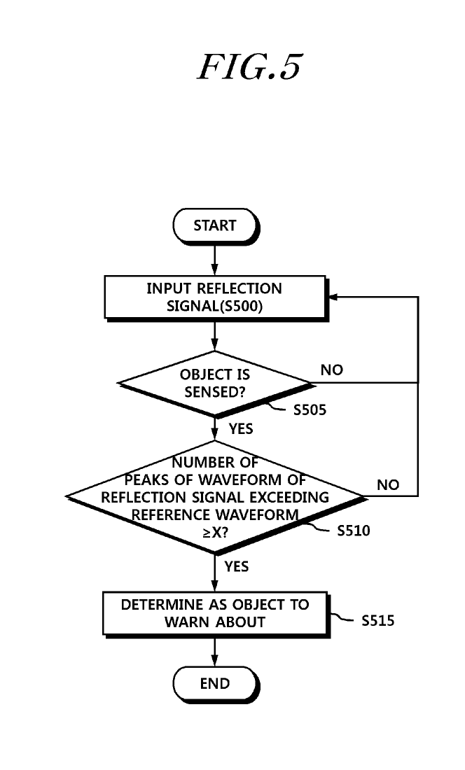

FIG. 5 is a flowchart illustrating a method of determining an object to warn about based on a reflection signal by the blind spot sensing apparatus, according to yet another exemplary embodiment of the present invention.

Referring to FIG. 5, the transceiver unit receives an input of a reflection signal reflected by an object or a water spray, from a sensor (S500).

The sensing unit determines whether an object is sensed based on the reflection signal (S505). For example, when the reflection signal is input or one or more peaks which exceed a sensing reference signal set for sensing and determining an object are sensed from the reflection signal sensing unit, the sensing unit determines that an object exists.

Thereafter, when the object is sensed, the determining unit compares the waveform of the reflection signal and the pre-set reference waveform and counts the number of peaks of the reflection signal, of which the signal intensities exceed the reference waveform (S510).

In addition, the determining unit compares the above-described count value and a pre-set reference value, and when the count value is equal to or larger than the reference value, the determining unit determines that the sensed object is moving. On the contrary, when the count value is smaller than the pre-set reference value, the determining unit determines the sensed object as a fixed object.

When the count value is equal to or larger than the pre-set reference value, the determining unit determines the corresponding object as an object to warn about (S515).

Thereafter, the blind spot sensing apparatus generates a warning signal to cause the driver to recognize the object to warn about.

Hereinafter, the blind spot sensing method according to the exemplary embodiment of the present invention described above with reference to FIGS. 1 to 5 will be briefly described again.

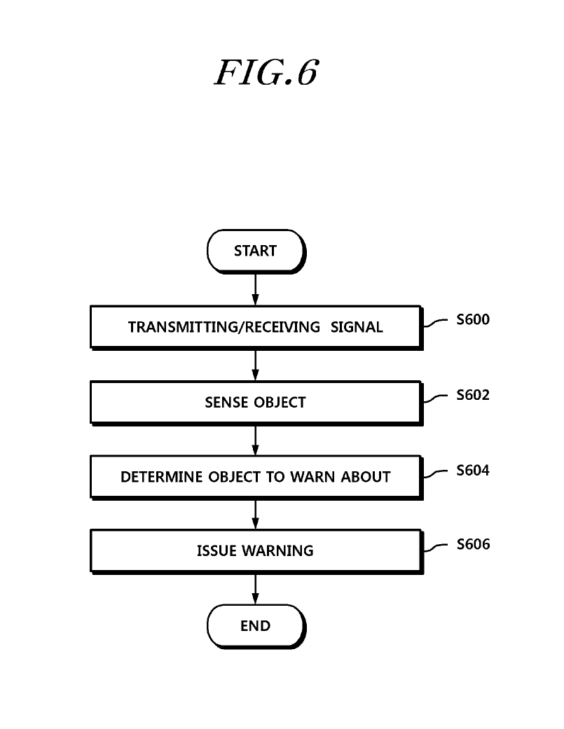

FIG. 6 is a flowchart of a blind spot sensing method according to yet another exemplary embodiment of the present invention.

According to an exemplary embodiment of the present invention, a blind spot sensing method may include: transmitting/receiving a signal for sensing an object existing in a vehicle blind spot; receiving the signal to sense the object; determining whether the sensed object is an object to warn about based on whether the sensed object moves; and when it is determined that the object is the object to warn about, generating a warning signal.

Referring to 6, the blind spot sensing method includes: transmitting a signal such as an ultrasonic signal or a radar signal and receiving a signal reflected by the object (S600).

Then, the blind spot sensing method includes: sensing a signal reflected by the object or a water spray generated by the object as the object moves and received so as to sense the existence of the object (S602).

In addition, the blind spot sensing method determines whether the sensed object is an object to warn about or not (S604).

Specifically, for example, when determining whether the sensed object is the object to warn about, the waveforms of the received reflection signal and the pre-set reference signal are compared so as to determine whether the sensed object is the object to warn about, and counts the number of peaks of the waveform of the reflection signal which have a signal intensity exceeding that of the waveform of the reference signal.

In addition, the above-described count value and the pre-set reference value are compared with each other and when the input reflection signal has the count value which exceeds the reference value, the reflection signal is determined as a reflection signal reflected by a water spray.

Accordingly, it is determined that the water spray is generated by the movement of the corresponding object and that the corresponding object is moving.

When it is determined that the corresponding object is moving, the blind spot sensing method further includes: determining whether the corresponding object is an object to warn about.

The blind spot sensing method further includes: generating a warning signal to issue a warning to the driver when the corresponding object is determined as the object to warn about (S606).

As described above, according to the present invention, it is possible to provide a blind spot sensing apparatus and method which sense water sprays generated by a moving object in case rain of or on a wet road so as to differentiate the moving object and the fixed object from each other.

Further, it is possible to provide a blind spot sensing apparatus and method which determine whether an object sensed through a sensor is an object to warn about and issue a warning only for the object to warn about.

Even if it was described above that all of the components of an embodiment of the present invention are coupled as a single unit or coupled to be operated as a single unit, the present invention is not necessarily limited to such an embodiment. At least two elements of all structural elements may be selectively joined and operate without departing from the scope of the present invention. Although the embodiments of the present invention have been described for illustrative purposes, those skilled in the art will appreciate that various modifications, additions and substitutions are possible, without departing from the scope and spirit of the invention. The scope of the present invention shall be construed on the basis of the accompanying claims in such a manner that all of the technical ideas included within the scope equivalent to the claims belong to the present invention.

What is claimed is:

1. A blind spot sensing apparatus comprising:
a transceiver unit configured to transmit/receive a signal for sensing an object existing in a vehicle blind spot;
a sensing unit configured to sense the object by receiving the signal;
a determining unit configured to determine whether the object is an object to warn about based on whether the sensed object moves or not; and
a warning unit configured to generate a warning signal when it is determined that the object is the object to warn about.

2. The apparatus of claim 1, wherein the sensing unit senses the object existing in the blind spot based on a reflected signal which is received by being reflected by the object or a water spray generated by the object.

3. The apparatus of claim 1, wherein the determining unit determines whether the object is moving by comparing a waveform of the reflected signal received by the transceiver unit with a reference waveform.

4. The apparatus of claim 3, wherein, when the number of peaks in the waveform of the reflection signal, which exceed the reference waveform, exceeds a reference value, the determining unit determines that the object is moving.

5. The apparatus of claim 4, wherein the reflection signal is a reflection signal reflected by a water spray generated by the moving object and received.

6. A blind spot sensing method comprising:
transmitting/receiving a signal for sensing an object existing in a vehicle blind spot;
sensing the object by receiving the signal;
determining whether the object is an object to warn about based on whether the object moves or not; and
generating a warning signal when it is determined that the object is the object to warn about.
